(19) United States
(12) Patent Application Publication
(10) Pub. No.: US 2007/0252503 A1
(43) Pub. Date: Nov. 1, 2007

(54) Spark plug having a reference electrode and an elongated electrode

(75) Inventor: Paul A. Rossi, Temecula, CA (US)

Correspondence Address: DOUGLAS W RUDY;LAW OFFICES OF DOUGLAS W. RUDY, LLC, 401 N. MICHIGAN AVENUE, SUITE 1200, CHICAGO, IL, 60611, US

(73) Assignee: TopFire Technologies, LLC, Bethel Park, PA (US)

(21) Appl. No.: 11/789,195

(22) Filed: Apr. 24, 2007

Related U.S. Application Data
(60) Provisional application No. 60/795,609, filed on Apr. 26, 2006.

(51) Int. Cl. H01T 13/20

(52) U.S. Cl. 313/141

(57) ABSTRACT

A spark plug having a reference electrode and one or more elongated electrodes located outboard from a center electrode of the spark plug. The reference electrode and the elongated electrodes each have serrations formed on surfaces facing the center electrode.

### CROSS REFERENCE TO RELATED APPLICATION

This application claims the benefit of Provisional Patent Application Ser. No. 60/795,609, filed Apr. 26, 2007 herein incorporated by reference in its entirety.

### BACKGROUND OF THE INVENTION

1. Field of the Invention

This invention relates to spark plugs having enhanced spark propagation and extended spark plug life. More particularly, it relates to spark plugs having a center electrode and more than one ground electrode, in this embodiment, a side electrode, each side electrode with multiple edge surfaces provided by serrations formed in the faces of the side electrodes facing the center electrode.

2. Description of the Prior Art

The sole purpose of a spark plug is to produce a spark when needed to ignite a combustive fuel and air mixture within an internal combustion engine. A high voltage is applied to a center electrode, and a spark is created when the voltage discharges to ground by jumping across a narrow gap between the center electrode and a ground electrode.

Each discharge at least slightly fouls the spot on the ground electrode where the spark strikes it. A fouled spot has more resistance to a discharge than an unfouled spot so subsequent sparks will follow a path of least resistance to the ground electrode and thus avoid the fouled spots. Over an extended period of time, however, the entire ground electrode will become fouled and the discharges of sparks will be impeded; eventually the plug will fail and require replacement.

Spark discharge also wears down the center electrode as well; it becomes physically shorter with the passage of time. Conventional ground electrodes thus become less and less effective as the center electrode wears down because the distance the spark must jump increases as the center electrode shortens.

One way to extend the useful lifetime of a spark plug is to increase the surface area of the ground electrode. One example of a ground electrode having an increased surface area is disclosed in U.S. Pat. No. 5,280,214 to Johnson, herein incorporated by reference.

For further information on the above, the reader is referred to the following issued patents, invented by Paul A. Rossi, the inventor of this invention, all of which patents are incorporated herein by reference: U.S. Pat. Nos. 5,892,319; 6,121,720; 6,362,562 and 6,338,661.

### SUMMARY OF THE INVENTION

A spark plug having at least one reference electrode integral with or affixed to a housing also includes a second electrode, an elongated electrode, also integral with or affixed to the housing is disclosed in this specification. In one embodiment, only two electrodes are carried on the spark plug housing while in other embodiments more than two side electrodes are integrated with or fastened to the housing. An embodiment preferred by the inventor, although not the only embodiment of the invention, will have four side electrodes, two reference electrodes and two elongated electrodes, interstitially dispersed around the periphery of the spark plug housing. One embodiment has the four electrodes equally spaced around the housing; however, spacing between electrodes may be adjusted to optimize the effectiveness of the spark plug.

In another embodiment three side electrodes are used. In this embodiment each of the side electrodes are of different lengths or heights thus providing a series of stepped serrated ends of the side electrodes where there will be three levels of spark paths between the side electrodes and the center electrode. A variation on this would be embodiments with two side electrodes of different lengths or four or more side electrodes of different lengths that would provide multiple levels of potential spark paths between the side electrodes and the center electrode.

The spark plug of this invention is useful in the lean-burning engines that are being developed. It is believed that fuel charges in a combustion chamber are now more stratified as better control of the fuel/air ratio is accomplished using fuel injection, variable advance valve timing, manifolding, and better fuel atomization techniques. This stratification results in pockets of fuel and air at an ideal stoichiometric ratio. Some of these pockets of stoichiometric fuel/air are in stratified layers at any point in time before ignition in the combustion chamber. If the spark plug is “fired,” i.e., an arc is caused to form when a layer of stoichiometric fuel/air surrounds the spark, there will be good combustion in the combustion chamber. If, however, a pocket of a lean fuel charge, a charge having a fuel-to-air ration that is not stoichiometric, is present in the spark zone of the spark plug, there is a chance that ignition of the fuel charge will misfire, be delayed, be incomplete or will not take place at all. The invention presented herein has the ability of having the spark occur at several elevations or levels along the height of the center electrode. These elevations or levels can be two, three or more than three levels. Multiple levels of side electrode faces will maximize the target zone where a spark will form between the side electrode and the center electrode. This maximizes the chance that a spark will occur in a pocket of fuel/air that is stoichiometric with the attendant efficient flame initiation from the spark.

This invention includes several embodiments, all of them characterized by more than one ground electrode surrounding a center electrode so that sparks may propagate from one or several vertical locations of the center electrode. Both, or all of, the several electrodes may be threaded, as can be the center electrode, or otherwise provided with surfaces that provide sharp edges that promote or facilitate spark propagation.

In one embodiment, a plurality of spaced serrations, flutes or sharp edges are formed in the side electrodes. The edges provide numerous spark-attracting edges about the center electrode, thereby greatly increasing the number of spark-attracting edges and thereby substantially extending the effective lifetime of the plug.

Still further embodiments include beveled surfaces, knurled surfaces, saw teeth, screw threads, concentric rings, and the like formed on or in the side electrode.

The purpose of the flutes, grooves, bevels, knurls, and other surfaces and edges cut into the side electrode is to provide a large plurality of sharp edges in the electrode. It has been found that such sharp edges provide a good path to ground for sparks. Since each edge will eventually become fouled, the large plurality of edges extends the lifetime of the plug.

An object of the invention is to provide a larger spark zone.

It is another object of the invention to provide a large spark propagation zone to ignite a lean fuel/air mixture.

Another object of the invention is to provide a broader and bigger target zone.

It is another object of the invention to have side electrodes of different lengths where different levels of spark propagation along the length of the center electrode are provided.

One object of the invention is to provide a spark plug having an extended lifetime.

A more specific object is to advance the art of spark plugs by providing side or ground electrodes of different lengths with a large plurality of sharp edges at various elevations along the height of the center electrode to further enhance their effectiveness.

Still another object is to provide a means for creating a combustion-enhancing air flow in the vicinity of the spark.

Another object of the invention is to define a zone of optimum spark propagation in a spark plug.

These and other important objects, features, and advantages of the invention will become apparent as this description proceeds.

In summary one embodiment of the invention is a spark plug having a body with a first end and a threaded portion having a surface at a second end of the body and a center electrode housed in the body of the spark plug. The center electrode extends longitudinally through the spark plug body. It may extend to the end of the extended electrode discussed below. A reference electrode extends from the surface of the threaded portion of the spark plug body and an extended electrode having a length greater than the length of the reference electrode extends from the surface of the threaded portion of the spark plug. In some embodiments the invention will include a second reference electrode extending from the surface of the threaded body portion of the spark plug body and in another embodiment may have a second extended electrode extending from the surface of the threaded body portion of the spark plug body. It is also contemplated to have a second reference electrode and a second extended electrode extending from the surface of the threaded body portion of the spark plug body.

The invention accordingly comprises the features of construction, combination of elements and arrangements of parts that will be exemplified in the construction hereinafter set forth, and the scope of the invention will be indicated in the claims

It will thus be seen that the objects set forth above, and those made apparent from the foregoing description, are efficiently attained. Since certain changes may be made in the foregoing construction without departing from the scope of the invention, it is intended that all matters contained in the foregoing construction or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between.

The above summary does not include an exhaustive list of all aspects of the present invention. The inventor contemplates that his invention includes all systems and methods that can be practiced from all suitable combinations of the various aspects summarized above, as well as those disclosed in the detailed description below and particularly pointed out in the claims filed with the application. Such combinations have particular advantages not specifically recited in the above summary.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112, ¶6. Thus, the use of the words “function,” “means” or “step” in the Detailed Description or Description of the Drawings or claims is not intended to somehow indicate a desire to invoke the special provisions of 35 U.S.C. § 112, ¶6, to define the invention. To the contrary, if the provisions of 35 U.S.C. § 112, ¶6 are sought to be invoked to define the inventions, the claims will specifically and expressly state the exact phrases “means' for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112, ¶6. Moreover, even if the provisions of 35 U.S.C. § 112, ¶6 are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE FIGURES

The preferred embodiments of the invention presented here are described below in the figures and Detailed Description of the Invention. Unless specifically noted, it is intended that the words and phrases in the specification and the claims be given the ordinary and accustomed meaning to those of ordinary skill in the applicable arts. If any other special meaning is intended for any word or phrase, the specification will clearly state and define the special meaning.

A more complete understanding of the present invention may be derived by referring to the detailed description when considered in connection with the following illustrative figures. In the figures, like reference numbers refer to like elements or acts throughout the figures.

FIG. 1 is a view of one embodiment of the invention showing two sets of side electrodes of different lengths;

FIG. 2 is an elevation view of the spark plug of FIG. 1 with the spark plug rotated to show the shorter of the four side electrodes in elevation;

FIG. 3 is an elevation view of the spark plug of FIG. 1 with the spark plug rotated to show the longer of the four side electrodes in elevation;

FIG. 4 is an enlarged portion view of the top or tip area of the spark plug shown in FIGS. 1-3;

FIG. 5 is an embodiment showing four side electrodes of equal length;

FIG. 6 is an embodiment showing two side electrodes of equal length:

FIG. 7 is an embodiment showing a multiple side electrodes each of a different length.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

Each variation of the invention is limited only by the recited limitations of its respective claim, and equivalents thereof, without limitation by other terms not present in the claim. Likewise, the use of the words “function” or “means” in the Detailed Description of the Drawings is not intended to indicate a desire to invoke the special provisions of 35 U.S.C. 112, Paragraph 6, to define the invention. To the contrary, if the provisions of 35 U.S.C. 112, Paragraph 6 are sought to be invoked to define the inventions, the claims will specifically state the phrases “means for” or “step for” and a function, without also reciting in such phrases any structure, material or act in support of the function. Even when the claims recite a “means for” or “step for” performing a function, if they also recite any structure, material or acts in support of that means or step, then the intention is not to invoke the provisions of 35 U.S.C. 112, Paragraph 6. Moreover, even if the provisions of 35 U.S.C. 112, Paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later-developed equivalent structures, material or acts for performing the claimed function.

Three pages of drawings are attached to this specification. Shown are at least three different embodiments of the invention. These include, but are not limited to; a spark plug having four side electrodes, two electrodes of one length and two of a second length, a spark plug having two equal length electrodes, a spark plug having four equal length side electrodes and a spark plug having three side electrodes of different lengths. Other configurations are also contemplated, such as a plug with two unequal length electrodes; a plug with an odd number of side electrodes of equal or unequal lengths; a plug with an even number of side electrodes of equal or unequal lengths.

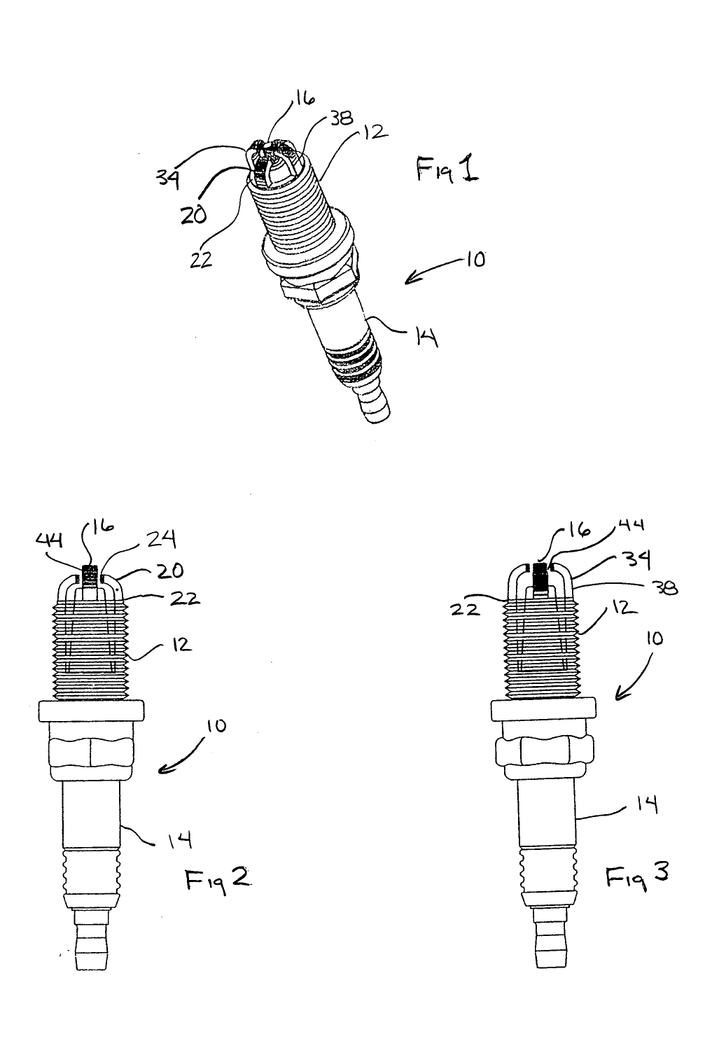

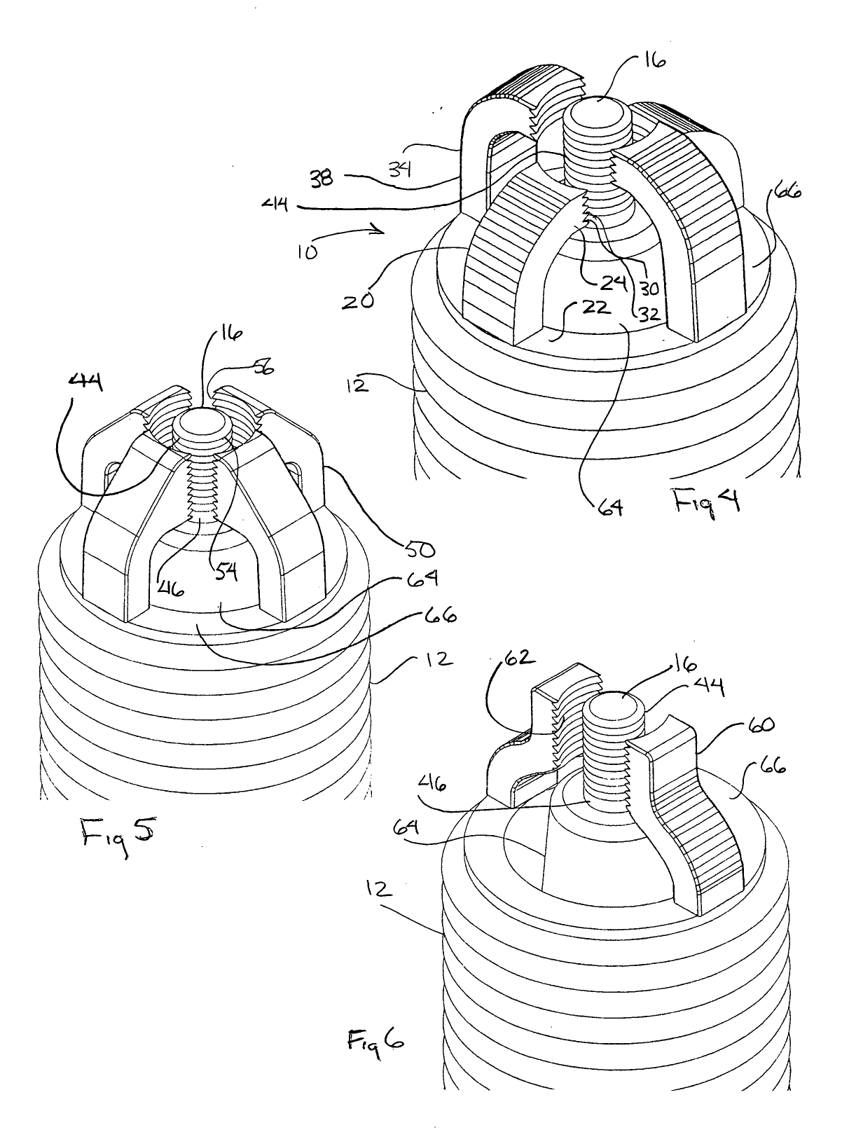

One embodiment of the invention is shown in FIGS. 1-4. A spark plug, generally 10, includes a threaded portion 12, an insulator 14 and a center electrode 16. Fastened to the threaded portion 12 of the spark plug is a side electrode 20. This side electrode is a reference electrode 20. The reference electrode 20 is of a given length from a base portion 22 to an end portion 24. The body 26 of the reference electrode 20 connects the base portion 22 of the electrode to the end portion 24 of the electrode.

As can be seen more clearly in FIG. 4 the end portion of the electrode 20 is provided with serrations 30 extending from a root portion 32. These serrations 30 may be, in one embodiment of the invention, a segment of a spiral-formed thread or spiral thread. Alternatively, the serrations could be parallel to each other and perpendicular or parallel to the major access of the side reference electrode 20.

An extended electrode 34 is similar to the reference electrode 20 in that it is attached to the threaded housing 12, has an end portion 36 and a body portion 38. This extended electrode 34 is slightly longer than the reference electrode 20. The length of the extended electrode 34, in one embodiment, is greater in the body portion 38 of the extended electrode 34 than the body portion 26 of the reference electrode 24.

As seen in FIGS. 1-4, the center electrode 16, which extends through the spark plug generally 10 from a first end 42 of the plug as is well known, may have a serrated surface as shown by serrations 44. In alternative embodiments the surface of the center electrode may formed without the serrations or with other surface finishes, such as, but not limited to, vertical grooves, spiral grooves, a roughened surface, or a surface having projections.

In operation of the plug shown in FIGS. 1-4, as most clearly shown in FIG. 4, the spark or electrical arc, resulting from a spark generation circuit will arc or spark between at least one side electrode and the center electrode. The spark may bridge from one, or more than one, of the serrations 30 on the side electrodes to the serrations of the center electrode, if serrations are provided on the center electrode, or to the center electrode even if serrations are not provided on the center electrode. The spark will propagate, in most instances, through a path of least resistant between one or more than one of the serrations on one or more then one of the side electrodes. In some instances the arc will be from one of the shorter side electrodes. In other instances the arc will be between one of the longer side electrodes and the center electrodes. The arc path is expected to be between areas of least resistance of both the center electrode and the side electrodes. It is expected that this path of least resistance will change over time as the spark plug wears, as it gets hotter or colder, as the voltage it is subjected to increases or decreases or, among other things, there is a build up of a residue on serrations of the side electrodes or the center electrode serrations or surface.

One advantage of the embodiment shown in FIGS. 1-4 is that with there being two sets of side electrodes, one set being of shorter length, that being the reference electrode 20 set, and a second set of two electrodes of longer length 34 then the reference electrodes 20, there is an expectation that gases in the vicinity of the tip of the spark plug may be less impeded in flowing into the zone of the spark plug where an electrical arc is formed between the side electrodes and the center electrode of the spark plug.

In another embodiment, the increased length of the extended electrode is in the tip area 40, that being the area from the free end of the extended electrode to the body portion 38 of the extended electrode. This tip area may be provided with the serrations or threads as shown as serrations 30 in FIG. 1.

FIGS. 4-7 show only the tip portion of a typical spark plug in the threaded body portion and the tip area. In these figures, which are only of a portion of the spark plug, but of a portion that is readily recognized by persons of ordinary skill in the art, the threaded portion 12 of the spark plug surrounds an insulator 64. The various side electrodes such as 20, 34, 50, and 60 are fastened, typically by welding the side electrodes to the surface 66 of the threaded section of the spark plugs. Alternative attachment processes of attaching the side electrodes to the upper surface of the threaded portion of the spark plug body are possible. For instance the side electrodes can be, among other techniques, friction welded to the upper surface 66. Also, the side electrodes can be formed integral with the metallic body of the sparkplug, either by casting or machining the metal part of the spark plug to be unified with at least a portion of the spark plug.

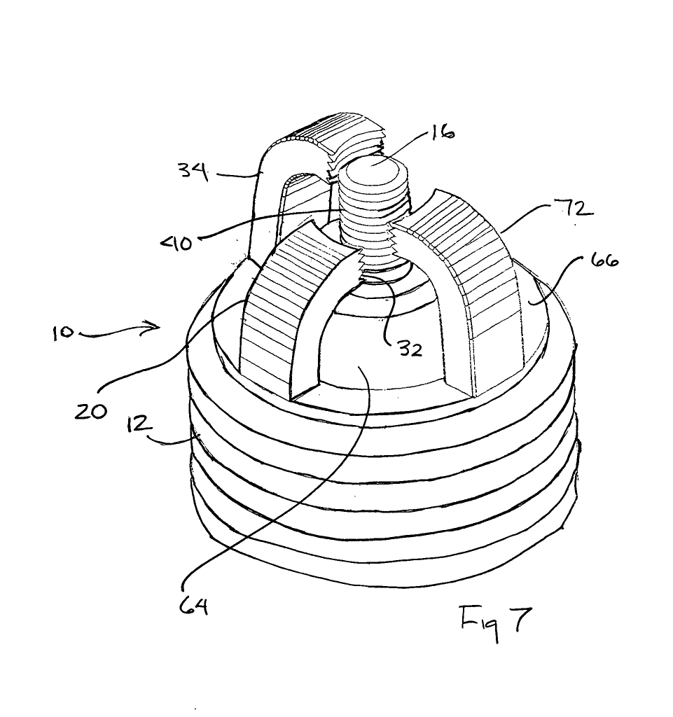

FIG. 5 is an alternative embodiment of the spark plugs of the invention shown in FIGS. 1-4. In this alternative embodiment the side electrodes 50, each of the four side electrodes 50 shown having the same configuration, have an increased length of serrated surfaces as compared to the embodiment shown in FIGS. 1-4. In this embodiment the serrated surfaces 52 of the side electrodes 50 are shown to extend coverage from the lower end 46 of the center electrode 16 to an upper end 54 of the center electrode. In this embodiment there are more side electrode serrations 56 on the side electrodes then there are in the embodiment shown in FIGS. 1-4, thus giving even more potential electrical arc paths between the side electrodes and the center electrode.

FIG. 6 presents an alternative embodiment to the spark plugs set forth in FIGS. 1-5. In this embodiment there are two side electrodes, one of the two identical side electrodes identified as 60, the side electrodes in this embodiment have serrated surfaces facing inwardly like the serrated surfaces in the other figures. In this embodiment the serrated surfaces of the side electrodes extend from the lower portion of the central electrode to the end of the central electrode 16. Gas flow, as influenced by the areas open and not blocked by the side electrodes, to the arc zone of the spark plug in this embodiment may be least restricted by the FIG. 6 embodiment.

FIG. 7 is an embodiment of the invention where there are three side electrodes. A first electrode will be the reference electrode 20. A mid-length electrode 70 will be attached to the surface 66 approximately one third of the circumference of the surface 66 away from the reference electrode 20. In this embodiment the extended electrode 34 is the longest of the three electrodes. It also is located on the surface 66 approximately one third of the circumference of the surface 66 away from the reference electrode 20 so that all three electrodes are evenly spaced around the center electrode 16.

In FIG. 7 three electrodes are shown, each of a different length. It is also contemplated that two, three, four or more electrodes can be used as an alternative to the three side electrodes shown in FIG. 7. In each of these embodiments one object is to provide a broad, big target zone where a cloud of gas, perhaps a lean mixture of fuel/air, has an improved chance of being ignited by the spark plug where the zone of spark propagation can be provided along the length of the center electrode.

In a simple embodiment the invention is a spark plug comprising a spark plug housing defining a longitudinal axis extending from a first end of the housing to a second opposing end of the housing; a center electrode disposed along the longitudinal axis of the housing and defining a first spark propagation surface at its free end, the free end of the central electrode being proximate the first end of the housing, and the first spark propagation surface extending a distance parallel to the longitudinal axis of the center electrode towards the second end of the housing; a reference electrode defining a second spark propagation surface proximate the first end of the housing, the second spark propagation surface radially spaced from the first spark propagation surface of the center electrode, and extending a distance parallel to the longitudinal axis of ground electrode towards the second end of the housing; an extended electrode defining a third spark propagation surface proximate the first end of the housing, the third spark propagation surface radially spaced from the first spark propagation surface of the center electrode, and extending a distance parallel to the longitudinal axis of ground electrode towards the second end of the housing; and the first, second and third spark propagation surfaces defining a zone of optimum spark propagation and defining parallel, opposing and longitudinally extending surface areas between which sparks may propagate at the free end of the center electrode.

In other embodiments and improvements there is a plurality of sharp edges formed in the longitudinally extending surface area of one of the spark propagation surfaces. Each of the sharp edges lying in a plane oblique to the longitudinal axis of the spark plug housing and the plurality of sharp edges provides a series of breaks along the surface of the electrode in which they are formed to continuously facilitate the propagation of sparks as the zone of optimum spark propagation changes with use of the spark plug. The first spark propagation surface of the center electrode may comprise a cylindrical conductor of defined radius and having a surface extending from a flat top surface towards the second end of the spark plug housing. The ground electrodes comprise a plurality of ground electrodes with each ground electrode being spaced apart from each other around the center electrode; and each of the ground electrodes further defines a spark propagation surface including a surface spaced radially from and concentric to respective facing areas of the surface of the center electrode. In one embodiment the ground electrodes comprise substantially saw-tooth-shaped projections circumferentially spaced around the cylindrical sidewall of the center electrode and a plurality of sharp edges are formed on the spark propagation surface of the center electrode. These sharp edges may comprise thread-like structures or knurls formed in the spark propagation surface of the center electrode. In the ground electrodes the spark propagation surfaces of the ground electrodes comprises thread-like structures or knurls formed in the spark propagation surfaces of the ground electrodes. The first spark propagation surface of the center electrode comprises a cylindrical conductor of defined radius while the ground electrodes comprise sidewalls spaced radially from and concentric to the surface of the center electrode, and beveled so as to provide a plurality of edge defining surfaces proximate the center electrode to enhance spark propagation.

The method possible with the apparatus set forth in this disclosure includes the method of improving the performance of a spark plug which comprises the acts of providing a spark plug having a body with a threaded portion having a surface, providing a reference electrode extending from the surface of the threaded portion of the spark plug body and providing an extended electrode having a length greater than the length of the reference electrode, the extended electrode extending from the surface of the threaded portion of the spark plug. Another embodiment of the method includes the act of providing a second reference electrode and a second extended electrode extending from the surface of the threaded body portion of the spark plug body.

While the invention is described herein in terms of preferred embodiments and generally associated methods, the inventor contemplates that alterations and permutations of the preferred embodiments and methods will become apparent to those skilled in the art upon a reading of the specification and a study of the drawings.

Accordingly, neither the above description of preferred exemplary embodiments nor the abstract defines or constrains the invention. Rather, the issued claims variously define the invention. Each variation of the invention is limited only by the recited limitations of its respective claim, and equivalents thereof, without limitation by other terms not present in the claim.

What is claimed is:

1. A spark plug having a body with a first end and a threaded portion having a surface at a second end of the body, a center electrode housed in the body of the spark plug, the center electrode extending longitudinally through the spark plug body, the spark plug further comprising:
a reference electrode extending from the surface of the threaded portion of the spark plug body;
an extended electrode having a length greater than the length of the reference electrode, the extended electrode extending from the surface of the threaded portion of the spark plug.

2. The apparatus of claim 1 further comprising a second reference electrode extending from the surface of the threaded body portion of the spark plug body.

3. The apparatus of claim 1 further comprising a second extended electrode extending from the surface of the threaded body portion of the spark plug body.

4. The apparatus of claim 1 further comprising a second reference electrode and a second extended electrode extending from the surface of the threaded body portion of the spark plug body.

5. The apparatus of claim 1 wherein the center electrode extends to the end of the extended electrode.

7. A spark plug comprising:
a spark plug housing defining a longitudinal axis extending from a first end of the housing to a second opposing end of the housing;
a center electrode disposed along the longitudinal axis of the housing and defining a first spark propagation surface at its free end, the free end of the central electrode being proximate the first end of the housing, and the first spark propagation surface extending a distance parallel to the longitudinal axis of the center electrode towards the second end of the housing;
a reference electrode defining a second spark propagation surface proximate the first end of the housing, the second spark propagation surface radially spaced from the first spark propagation surface of the center electrode, and extending a distance parallel to the longitudinal axis of ground electrode towards the second end of the housing;
an extended electrode defining a third spark propagation surface proximate the first end of the housing, the third spark propagation surface radially spaced from the first spark propagation surface of the center electrode, and extending a distance parallel to the longitudinal axis of ground electrode towards the second end of the housing;
the first, second and third spark propagation surfaces defining a zone of optimum spark propagation and defining parallel, opposing and longitudinally extending surface areas between which sparks may propagate at the free end of the center electrode.

8. The spark plug of claim 7 further comprising a plurality of sharp edges formed in the longitudinally extending surface area of one of the spark propagation surfaces, each of the sharp edges lying in a plane oblique to the longitudinal axis of the spark plug housing, and the plurality of sharp edges providing a series of breaks along the surface of the electrode in which they are formed to continuously facilitate the propagation of sparks as the zone of optimum spark propagation changes with use of the spark plug.

9. The spark plug of claim 7 wherein,
the first spark propagation surface of the center electrode comprises a cylindrical conductor of defined radius and having a surface extending from a flat top surface towards the second end of the spark plug housing;
the ground electrodes comprise a plurality of ground electrodes, each ground electrode being spaced apart from each other around the center electrode; and
each of the ground electrodes further defines a spark propagation surface including a surface spaced radially from and concentric to respective facing areas of the surface of the center electrode.

10. The spark plug of claim 9 wherein the ground electrodes comprise electrodes of different lengths such that the ground electrodes have serrated surfaces that, taken together, extend along the first spark propagation surface of the center electrode.

11. The spark plug of claim 10 wherein the ground electrodes comprise substantially saw-tooth-shaped projections circumferentially spaced around the cylindrical sidewall of the center electrode.

12. The spark plug of claim 10 wherein a plurality of sharp edges are formed on the spark propagation surface of the center electrode.

13. The spark plug of claim 12 wherein the plurality of sharp edges comprises thread-like structures formed in the spark propagation surface of the center electrode.

14. The spark plug of claim 12 wherein the plurality of sharp edges comprises knurls formed in the spark propagation surface of the center electrode.

15. The spark plug of claim 10 wherein the plurality of sharp edges is formed in the spark propagation surfaces of the ground electrodes.

16. The spark plug of claim 15 wherein the plurality of sharp edges comprises thread-like structures formed in the spark propagation surfaces of the ground electrodes.

17. The spark plug of claim 15 wherein the plurality of sharp edges comprises knurls formed in the spark propagation surfaces of the ground electrodes.

18. The spark plug of claim 8 wherein:
the first spark propagation surface of the center electrode comprises a cylindrical conductor of defined radius;
the ground electrodes comprise sidewalls spaced radially from and concentric to the surface of the center electrode, and beveled so as to provide a plurality of edge defining surfaces proximate the center electrode to enhance spark propagation.

19. The method of improving the performance of a spark plug comprising the acts of:
providing a spark plug having a body with a threaded portion having a surface;
providing a reference electrode extending from the surface of the threaded portion of the spark plug body;
providing an extended electrode having a length greater than the length of the reference electrode, the extended electrode extending from the surface of the threaded portion of the spark plug.

20. The method set forth in claim 19 including the act of providing a second reference electrode and a second extended electrode extending from the surface of the threaded body portion of the spark plug body.
